(19) United States
(12) Patent Application Publication
(10) Pub. No.: US 2021/0111494 A1
(43) Pub. Date: Apr. 15, 2021

(54) ANTENNA

(71) Applicant: Yellow Sands Technologies, Ltd, Sderot (IL)

(72) Inventors: Motti Haridim, Givat Zeev (IL); Chaim Shine, London (GB)

(73) Assignee: Yellow Sands Technologies, Ltd., Sderot (IL)

(21) Appl. No.: 17/070,507

(22) Filed: Oct. 14, 2020

Related U.S. Application Data
(60) Provisional application No. 62/915,054, filed on Oct. 15, 2019.

(51) Int. Cl. H01Q 11/14; H01Q 5/15

(52) U.S. Cl. CPC H01Q 11/14; H01Q 5/15

(57) ABSTRACT

An antenna has a feed element and at least one radiating element having a straight portion which extends from the feed dement and a non-straight portion which extends from the straight portion and can be of a meander shape or a wave shape.

### BACKGROUND OF THE INVENTION

The present invention relates to antennas.

Antennas are used in many areas , and as a not limiting example in wireless radio systems and other applications, in which they are required to be of a small size.

In applications requiring antennas of an omni-directional pattern, tuned monopole antennas as well as dipole antennas can be used as they exhibit good characteristics in terms of radiation pattern, input impedance, etc. The length of these antennas is determined by the desired operation frequency. The total length of a tuned dipole is a half wavelength at the center frequency and the length of a tuned monopole is a quarter wave of the center frequency. At low frequencies as well as in applications with space constraint, the length of such antennas can be inconveniently large. For this reason, various modified versions have been proposed in order to reduce the length of such antennas.

It is known to use non-straight line structures of different shapes for reducing the size (especially the length) of wire antennas. In these antennas, the radiating element is made in the shape of a non-straight line. Since the resonance frequency of these antennas is determined by the length of the current trace, the non-straight line structure allows for shortening the antenna length for a given (desired) trace length. However, while effective for reducing the antenna length, the non-straight line structure results in deterioration of the antenna performance in terms of radiation efficiency and gain.

### SUMMARY OF THE INVENTION

Accordingly, it is an object of the present invention to provide an antenna which avoids the disadvantages of the prior art.

In keeping with these objects and with others which will become apparent hereinafter, one feature of the present invention resides, briefly stated in an antenna which has at least one radiating element having a straight part with one end extending from a feed point and with an opposite end, and a non-straight part extending from the opposite end of the straight part.

When the antenna is designed in accordance with the present invention the efficiency and gain of the antenna is not significantly affected by the non-straight part of the radiating element, and therefore it substantially eliminates the problems caused by the limitations and disadvantages of antennas with radiating elements composed exclusively of non-straight parts.

According to a further feature of the present invention the non-straight part of the at least one radiating element is formed as a meandering non-straight part.

According to a further feature of the present invention the non-straight part of the at least one radiating element is formed as a wavy non-straight part.

According to a further feature of the present invention the antenna is a dipole antenna and has two radiating elements located at opposite sides of the feed and each including the straight part having the one end extending the feed and the opposite end, and the non-straight part extending from an opposite end of the straight part.

According to a further feature of the present invention the antenna is a monopole antenna and has at least one radiating element with the straight part having one end extending the feed and the opposite end and the non-straight part extending from an opposite end of the straight part, with the one radiating element located at one side of the feed, and a ground portion constituting a voltage nullifier circuit is located connected to another opposite feed, directly or through a conducting pad.

According to still a further feature of the present invention the nullifier includes a non-straight portion extending from the opposite side of the area of the feed and an additional straight portion extending under this portion toward the feed and connected with the upper non-straight portion at an end which is opposite to the area of the feed.

According to still a further feature of the present invention the non-straight part of the at least one radiating element has an upper non-straight portion extending from the opposite end of the straight part and a lower non-straight portion extending toward the area of the feed substantially along the upper non-straight portion and connected with the upper non-straight portion at an end with each distant from the area of the feed.

According to a further feature of the present invention in the radiating element the non-straight part extending from the opposite end of the straight part is oriented transversely to the straight part.

### BRIEF DESCRIPTION OF THE DRAWINGS

FIG. 1 is a view showing a dipole antenna configured in accordance with a prior art and having two arms with the entire length of each arm is meander-shaped;

FIG. 2 is a view showing a monopole antenna configured in accordance with a prior art, in which the radiating element is meander-shaped over its entire length, a monopole is printed on a substrate and fed by a transmission line, and a ground plane is implemented on a bottom side of the substrate parallel to a transmission line;

FIG. 3 is a view showing a dipole antenna with radiating elements according to one embodiment of the present invention;

FIG. 4 is a view showing a monopole antenna with a radiating element and a nullifier according to another embodiment of the present invention;

FIG. 5 is a view shows showing an antenna according to a further embodiment of the present invention;

FIG. 6 is a view showing is a dipole antenna according to still a further embodiment of the present invention;

FIG. 7 is a view showing an antenna of the present invention with a three-dimensional monopole configuration, with a ground plate perpendicular to the radiating element;

FIG. 8 is a view showing an antenna of the present invention with another configuration;

FIG. 9 is a view showing an antenna of the present invention with a further configuration;

FIG. 10 is a view showing an antenna of the present invention with still a further configuration;

FIG. 11 is a view showing an antenna of the present invention with still a further configuration; and

FIG. 12 is a view showing an antenna of the present invention with an additional configuration.

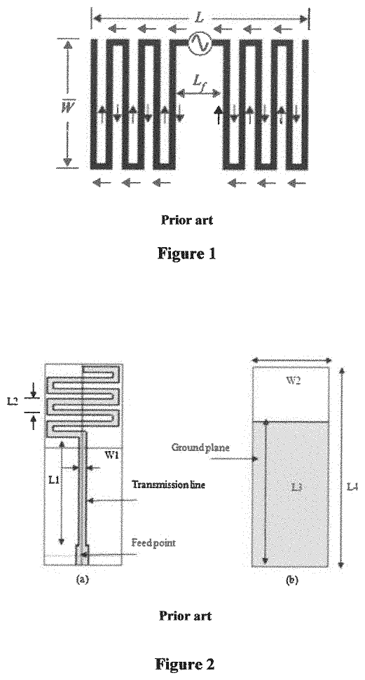

### DESCRIPTION OF THE PREFERRED EMBODIMENTS

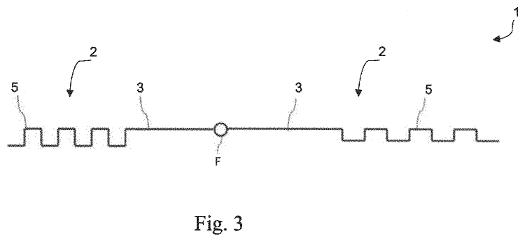

An antenna 1 according to one embodiment of the present invention is shown in FIG. 3. It has a dipole (symmetrical) configuration and has two radiating elements 2. Each of the radiating elements 1 has a straight portion 3 with one end connected a feed F and a non-straight portion 5 connected to an opposite end of the straight portion 3. Each of the non-straight portions 5 can be a meander-shaped portion or a wave-shaped.

The contribution of the non-straight portions 4 to the antenna radiation efficiency is low due to the fact that anti-phase currents flow in parallel segments. To obviate this disadvantage, the antenna uses the non-straight portions 5 which constitute only as a part of each radiating element 2 and each extend from the end of the corresponding straight portion 3, which end of the straight portion is opposite to the feed area.

The non-straight portions are located away from the feed, so that the current flowing in this part is of a low amplitude. Therefore, the dipole arms near the feed are straight-lines as in the case of conventional dipoles, and as such their contribution to the radiation is dominant, as in the case of conventional tuned dipoles.

While the resonance frequency of the antenna is determined by the length of the whole current path in the antenna including the straight portions 3 and the non-straight portions 5, the main contribution to the radiation stems from the straight portions 3, in which the current amplitude is high. The ratio between the lengths of the straight portions 3 and the non-straight portions 5 can be designed as an optimum compromise for a minimal antenna length and a maximum efficiency and gain.

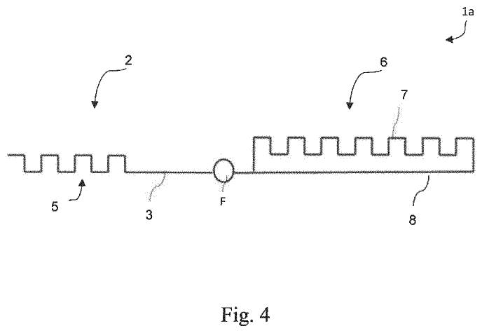

The antenna 1a according to a further feature of the present invention having a monopole configuration is shown in FIG. 4. It has a radiating element 2 with the straight part 3 having one end with a feed F and extending from the feed F, the opposite end and the non-straight part 5 extend from the opposite end of the straight part 3. While the radiating element 2 is connected to the feed point, the antenna of this embodiment further has a nullifier 6 providing nullified (zero) potential hence acting as a ground plane and located at another opposite side of the area of the feed F.

The nullifier 6 consists of a rectangular loop in which an upper non-straight portion 7 extends from the opposite side of the area of the feed and formed for example as a meandering portion or a wave-shaped portion and an additional lower straight portion 8 extending under the upper non-straight portion 7 toward the area of the feed. The lower straight portion 8 is connected with the upper non-straight portion 7 at an end which is opposite to the area of the feed. The nullifier 6 operates as a grounding and nullifies a potential at one of the feed points.

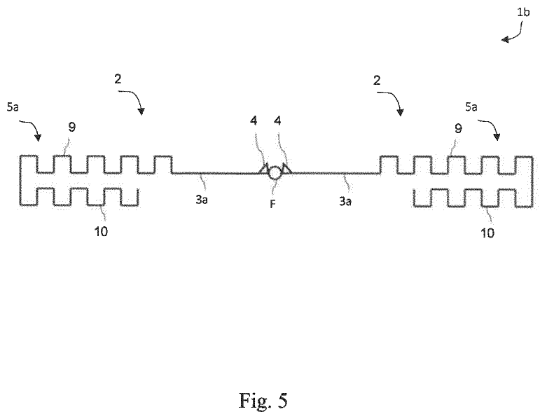

The antenna 1b according to a further embodiment of the present invention is shown in FIG. 5. It has two radiating elements 2 each having a straight part 3a and a non-straight part 5a. Each of the non-straight parts 5a has an upper non-straight portion 9 extending from the opposite end of the straight part 3a and a lower non-straight portion 10 extending toward the area of feed pads 4 substantially along the upper non-straight portion 9. Each of the lower non-straight portions 10 is connected with the corresponding upper non-straight portion 9 at an end with each distant from the area of the feed pads 4 and the feed element F.

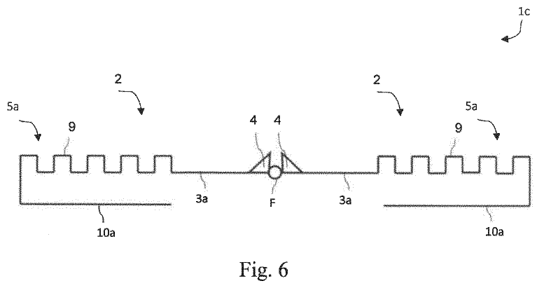

The antenna 1c according to a further embodiment of the present invention is shown in FIG. 6. It has two radiating elements 2 each having a straight part 3b and a non-straight part 5a. Each of the non-straight parts 5a has an upper non-straight portion 9 extending from the opposite end of the straight part 3a and a lower straight line 10a folded back towards the feed area substantially along the upper non-straight portion.

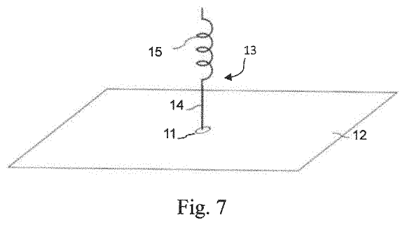

In the antenna of the present invention the radiating elements can be three-dimensional and the antenna can have a three-dimensional monopole configuration as shown in FIG. 7. It has a feed element 11, a ground plate 12 and a radiating element 13 which extends perpendicular to the ground plate 12 and has a straight portion 14 and a spiral-shaped portion 15.

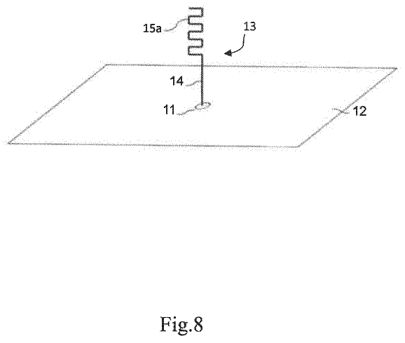

FIG. 8 shows another embodiment of the antenna of the present invention in a three-dimensional monopole configuration. It has a feed element 11, a ground plate 12, and a radiating element 13 which extends perpendicular to the ground plate 12 and has a straight portion 14 and a meandering portion 15a.

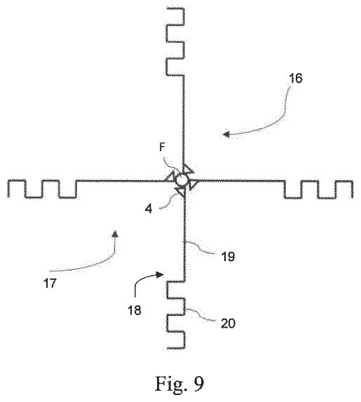

The antenna of the present invention can also have a cross-shaped dipole configuration as shown in FIG. 9 with dipoles 16 and 17 each having radiating elements 18 with a straight portion 19 and a meandering portion 20 with an appropriate feed scheme in order to provide a circular polarization.

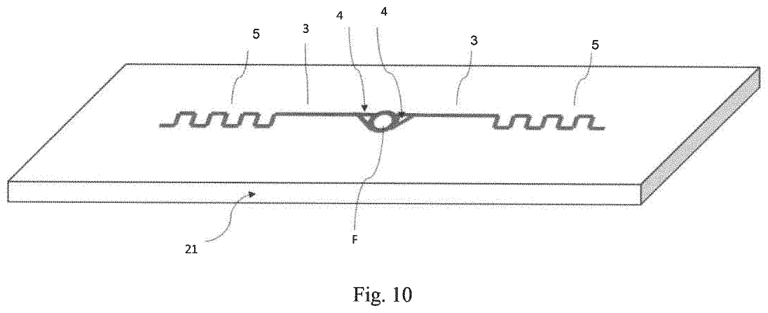

The antenna of the present invention can also be printed on a dielectric substrate 21 as shown in FIG. 10. It is a printed dipole configuration of the antenna, where each of the two radiating elements consists of a straight line 3 connected to feed pad 4 and a meandering line 5 connected at the end of the straight line 3.

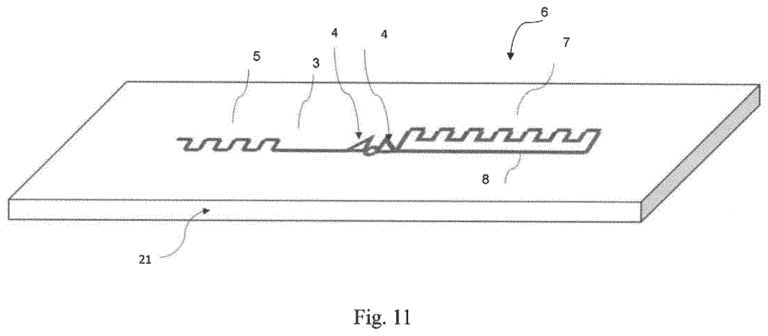

FIG. 11 shows a printed monopole configuration of the antenna using a voltage nullifier acting as the ground portion. The radiating element consists of a straight line 3 connected to feed pad 4 and a meandering line 5 connected at the end of the straight line 3. The nullifier 6 is a loop consisting of a meandering portion 7 and a straight line 8, and is connected to the feed pad 4.

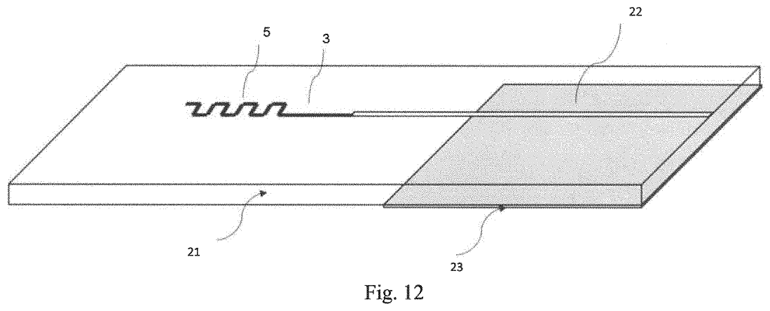

FIG. 12 shows a printed monopole configuration of the antenna fed by a transmission line. The radiating element is printed on a dielectric substrate 21 and consists of a straight line 3 connected to a feeding transmission line 22 and a meandering line 5 connected at the end of the straight line 3. The ground portion 23 is implemented on the bottom side of the substrate 21 parallel to the transmission line 22.

In the antenna of the present invention a high-permittivity substrate on which the radiating elements are arranged can be used for further reduction of the antenna dimensions.

The antenna of the present invention can be realized in wired antenna configuration, such as monopole o r dipole, in different ways. These include:
(1) 3-dimensional antennas in which the radiating elements are made of wires and the ground portion, in the case of monopole, is made of a conducting plate,
(2) Printed antenna, where the radiating elements and the ground plane, in the case of monopoles, are printed as planar strips on top of a dielectric substrate,
(3) Monopoles using a voltage nullifier as a ground portion,
(4) Monopole or dipole antennas printed on a dielectric substrate layer and covered by a superstrate layer, the substrate and the superstrate layers can be composed of a biocompatible material, and the antenna can be implemented as an implantable printed antenna encapsulated by the substrate layer and superstrate layers.

The antenna of the present invention can also comprise additional components selected from the group consisting of reactive components, active components, and both and obtaining or improving matching between the antenna and a source or a load.

What is desired to be protected by Letters Patent is set forth in particular in the appended claims.

What we claim is:

1. An antenna, comprising at least one radiating element having a straight portion with one end and another opposite end and a non-straight portion extending from the opposite end of the straight portion:

2. An antenna of claim 1, wherein the radiating element with said straight portion and said non-straight portion is a three-dimensional conductor formed as a wire.

3. An antenna of claim 1, wherein the non-straight portion of the at least one radiating element is a meander-shaped portion.

4. An antenna of claim 1, wherein the non-straight portion of the at least one radiating element is a spiral-shaped portion.

5. An antenna of claim 1, wherein the one radiating element is connected to a feed element; and further comprising another radiating element located at an opposite side of the feed element and having a straight portion with one end connected to the feed element and another opposite end, and a non-straight portion extending from the opposite end of the straight portion.

6. An antenna of claim 1, realized in a monopole configuration, wherein the one radiating element is connected to a feed element at one side; and further comprising a voltage nullifier acting as a ground plane and connected to the feed element at another opposite side.

7. An antenna of claim 6, wherein the voltage nullifier has a loop which includes a non-straight portion.

8. An antenna of claim 1, comprising two said radiating elements located at opposite sides of the feed element and each having the straight part and the non-straight part, wherein each of the non-straight parts consists of a combination of meander, folded and spiral sections, including straight lines.

9. An antenna of claim 1, comprising two said radiating elements located at opposite sides of a feed area and each having the straight part and the non-straight part, the non-straight part of each of the radiating elements extending from an opposite end of the corresponding straight part transversely to the straight part.

10. An antenna of claim 1, wherein the radiating element is composed of a three-dimensional wire, and the antenna has a three-dimensional monopole configuration with the radiating element perpendicular to a ground plane.

11. An antenna of claim 1, wherein the radiating elements are planar strips printed on a dielectric substrate.

12. An antenna of claim 1, further comprising a substrate layer and a superstrate layer between which the radiating element is located, the substrate and the superstrate layers being composed of a biocompatible material, and the antenna being implemented as an implantable printed antenna encapsulated by the substrate layer and superstrate layers.

13. An antenna of claim 1, and further comprising additional components selected from the group consisting of reactive components, active components, and both for obtaining or improving matching between the antenna and a source or a load.

14. An antenna of claim 1, wherein the antenna is configured to provide a circular polarization.

15. An antenna array, comprising a plurality of array elements each formed as antenna defined in claim 1, in a dipole or a monopole configuration.
